(19) United States
(12) Patent Application Publication
(10) Pub. No.: US 2003/0177828 A1
(43) Pub. Date: Sep. 25, 2003

(54) Luminescent gauge

(76) Inventors: Yvon Bedard, Orford (CA); Andre Fournier, Sherbrooke (CA)

Correspondence Address: PILLSBURY WINTHROP, LLP, P.O. BOX 10500, MCLEAN, VA, 22102, US

(21) Appl. No.: 10/373,593

(22) Filed: Feb. 26, 2003

Related U.S. Application Data
(60) Provisional application No. 60/359,377, filed on Feb. 26, 2002.

(51) Int. Cl. G01F 23/36

(52) U.S. Cl. 73/313

(57) ABSTRACT

The present invention is directed generally to a gauge with a body. A twisted wire is disposed through the body, and an indicator is fixedly disposed on the twisted wire. A light source is disposed adjacent the body to illuminate the indicator. In addition, a float is slidably disposed on the twisted wire in a fixed orientation with respect to the body such that movement of the float along the twisted wire rotates the twisted wire and the indicator. The present invention also provides for the construction of a fuel tank and a snowmobile that include this gauge.

This application claims the benefit of priority of U.S. Provisional Patent Application Serial No. 60/359,377, which was filed on Feb. 26, 2002, the contents of which are incorporated by reference in their entirety.

### FIELD OF THE INVENTION

The field of the present invention relates to illuminated gauges of the type, which indicate the level of liquid in a vessel or container, such as a fuel tank.

### BACKGROUND OF THE INVENTION

Fuel gauges are widely used to indicate the level of liquid remaining in a vessel or container, such as a fuel tank, so that a person may accurately monitor the level of liquid without having to open the tank to make a visual inspection. Conventionally, many gauges use floating mechanisms to indicate the level of fuel remaining in the tank.

One type of construction known in the art is described and depicted in U.S. Pat. No. 4,724,706 (“the '706 patent”). The '706 patent is directed to a gauge used to measure the level of a gas/oil mixture in a fuel tank. Specifically, the gauge includes a float disposed on a twisted wire. Means are provided to hold the float in a fixed radial orientation so that the float does not turn as it follows the fuel level in the tank and moves vertically along the wire.

The gauge described in the '706 patent provides information relating to how to refill such a tank with the specified gas/oil mixture. This gauge is situated over the hole in the tank where fuel is added. One benefit of the gauge described in the '706 patent is that the gauge is simple in its construction and yet it works well. As a result, the gauge described in the '706 patent reduces manufacturing costs of the vehicle in which it is placed, reduces manufacturing time, and improves reliability.

One drawback associated with this gauge, however, is that it does not include any light source or other means to illuminate the oil/fuel level indicator. As a result, the amount of oil/fuel mixture remaining in the tank cannot be determined easily at night or in an environment with low-intensity ambient light.

In addition, the gauge depicted in the '706 patent suffers from a second drawback. Being attached to the bottom side of the filler cap, the mechanism that actuates the gauge must be extracted from the tank each time fuel is added. Invariably, this results in spillage of fuel each time the gauge and its associated mechanism are removed. In addition, gauges of this type are somewhat inconvenient to use. Because the gauge must be removed to refill the tank, the user must find a clean surface on which to set the gauge so that the gauge does not come in contact with any particles which could possibly stick to the gauge and be inserted into the tank once the gauge is replaced.

A second type of construction for a prior art gauge is depicted in U.S. Pat. No. 4,970,896 (“the '896 patent”). The '896 patent describes a float activated gauge with a frame for restraining lateral and rotational movement of the float. At the same time, the gauge's frame allows vertical movement of the float in response to the level of liquid in the tank. As with the gauge described in the '706 patent, the gauge described in the '896 patent also fails to include a light source or other means to light up the fuel level indicator. As a result, the fuel gauge cannot be read easily in dark environments, such as at night. The simple structure of the '706 patent is also incorporated into gauge described in the '896 patent. One improvement offered by the gauge of the '896 patent over that of the '706 patent is that the gauge described in the '896 patent is located in a hole other than the hole that is used to refill the tank and, therefore, is not removed together with the filler cap when the tank is refueled.

A second type of fuel gauge that is commercially available is the illuminated, electric fuel gauge. Unlike the previous two examples, the level indicator for the electric fuel gauge is not directly connected to the float. Instead, the indicator is mounted remotely from the fuel tank (usually on a dashboard or similar structure on the vehicle) and is actuated by a measuring mechanism enclosed within the tank. To measure the fuel level in the tank, electric fuel gauges usually are connected to a floating arm that rises and falls with the level of fluid in the tank. Vertical movement of the float in the tank is converted to rotational movement of the needle on the gauge through an electrical output, which is transmitted to the fuel level indicator via a wire.

Mounting the float for an electrical fuel gauge in the tank requires an entry in the rear of the fuel tank so as not to expose the electric wires. The entry needed to install the floating arm for the electric fuel gauge is also near the bottom on the tank to have sufficient space for the floating arm to swing. This requires that the entry must be sealed from any leakage once the float has been installed. A drawback associated with this type of illuminated fuel gauge is it is not interchangeable with a fuel gauge that is not electric or illuminated, such as the fuel gauge described and shown in the '896 patent.

Some customers prefer that the vehicles they purchase include an non-illuminated fuel gauge. Others would rather pay more to have an illuminated gauge. Regardless of consumer preference, manufacturers would rather produce a single fuel tank in which either gauge could be placed in the same opening without any further modification of the vehicle (e.g., the snowmobile) or the tank itself. Currently, if a customer decides to upgrade their non-illuminated fuel gauge to an illuminated fuel gauge, the entire fuel tank must be removed in order to install the currently-available, illuminated fuel gauge (with a remote indicator). The installation requires making a hole in the tank for the float and also making a hole in the control panel for the fuel level indicator.

Despite the types of gauges available in the prior art, there are no gauges that provide a simple, cost-effective, reliable, interchangeable, and illuminated indication of fuel level in a fuel tank.

### SUMMARY OF INVENTION

It is, therefore, an object of the present invention to provide a simple, cost-effective, reliable illuminated gauge with improved characteristics.

It is another object of the present invention to provide a gauge that may replace an existing fuel gauge without any further modifications to the tank or the vehicle in which the gauge is installed.

It is a further object of the present invention to provide a gauge where the connection between the fuel level indicator is mechanical and not electrical.

In furtherance of these objects, one aspect of the present invention is to provide a gauge with a body. A twisted wire is disposed through the body with an indicator fixed on the twisted wire and a float slidably connected on the twisted wire. A light source is disposed near the body of the gauge to illuminate the indicator when ambient light conditions are not sufficient to see the indicator.

Another aspect of the present invention is to provide a light conductor disposed near the light source to illuminate the indicator. The light conductor can be disposed under the indicator or above the indicator.

Yet another aspect of the present invention is to provide a light conductor that doubles as a crystal disposed over the indicator.

Still another aspect of the present invention provides the body with a semicircular cavity extending around the twisted wire in which the light conductor lies when placed below the indicator.

Another aspect of the present invention is to provide an float attenuating means that doubles a guide for the float as it slides on the twisted wire.

According to another aspect of the present invention, a fuel tank is provided having a vessel with a top adapted to contain fuel. The vessel defines a hole through the top through which a gauge may be inserted. The gauge includes a body with a twisted wire disposed through the body. An indicator is fixedly disposed on the twisted wire, and a float is slidably positioned on the twisted wire. A light source is disposed near the body of the gauge to illuminate the indicator when there is an absence of sufficient ambient light to see the indicator.

According to yet another aspect of the present invention, a snowmobile is provided includes a chassis. An engine is disposed on the chassis. A steering column is attached to at least one ski for steering the snowmobile over the snow. An endless track is disposed under the chassis and is operatively connected to the engine for propelling the snowmobile. The snowmobile includes a fuel tank with a vessel having a top adapted to contain fuel. The vessel defines a hole through the top through which a gauge is placed. The gauge has a body with a twisted wire disposed therethrough. An indicator is fixedly disposed on the twisted wire, and a float is slidably positioned on the twisted wire. A light source is disposed near the body of the gauge to illuminate the indicator when the ambient light does not permit the operator to see the indicator easily.

### BRIEF DESCRIPTION OF THE DRAWINGS

Reference will be made hereinafter to the accompanying drawings, which illustrate embodiments of the present invention discussed herein below, wherein:

FIG. 1 is a top perspective view showing an embodiment of the prior art;

FIG. 2 is a cross-sectional view of the prior-art gauge shown in FIG. 1;

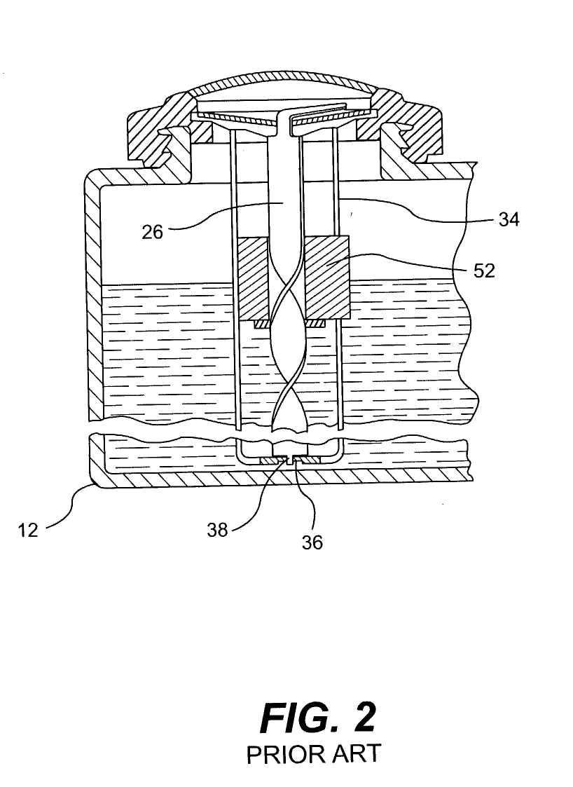

FIG. 3 is an exploded view of the first embodiment of the gauge in accordance with the present invention;

FIG. 4 is a partial cross-sectional view of the gauge shown in FIG. 3 in accordance with the present invention;

FIG. 5 is an exploded view of the second embodiment of the gauge in accordance with the present invention;

FIG. 6 is a partial cross-sectional view of the gauge shown in FIG. 5 in accordance with the present invention;

FIG. 7 is a cross-sectional view of the gauge shown in FIG. 3 in accordance with the present invention illustrating more fully the design of the fuel gauge;

FIG. 8 is a side view of a snowmobile with a fuel tank and the gauge according to the present invention; and

FIG. 9 is a perspective view of the gauge of the present invention with a float attenuator.

### DETAILED DESCRIPTION OF THE PREFERRED EMBODIMENTS

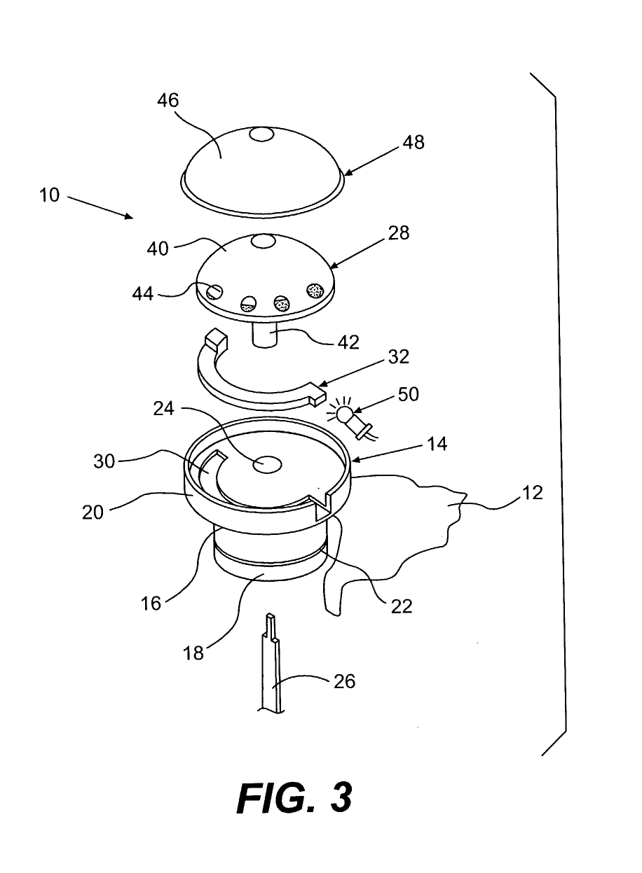

A gauge 10 according to the teachings of the present invention is shown in FIGS. 3-9. The gauge 10 is preferably circular in shape but, as would be known to those skilled in the art, the gauge 10 could be made in any shape or size suitable for use in a vessel 12. The gauge 10 also is preferably made from polyethylene and metal. However, as would be known to anyone skilled in the art, the gauge 10 could be made from any suitable material(s) resistant to degradation by fuel or oil, since this is the environment is which the gauge is designed to operate.

In the embodiment illustrated in FIG. 3, the body 14 of gauge 10, is cylindrical in shape with a shoulder 16 separating the lower portion 18 of the body 14 inserted into the tank 12 and the upper portion 20 remaining outside the tank 12. The lower portion 18 of the body 14 has a circular ridge 22 to seal the lower portion 18 in the tank 12. The ridge 22 is preferably molded into the lower portion 18 of body 14 but, as would be known to those skilled in the art, other methods of sealing also are available.

The connection between the body 14 and the tank 12 is preferably a press-fit. However, those skilled in the art would recognize that body 14 could be connected to the tank 12 by other suitable means. For example, the body 14 may be screw-fit into the opening provided through the wall of the tank or vessel 12.

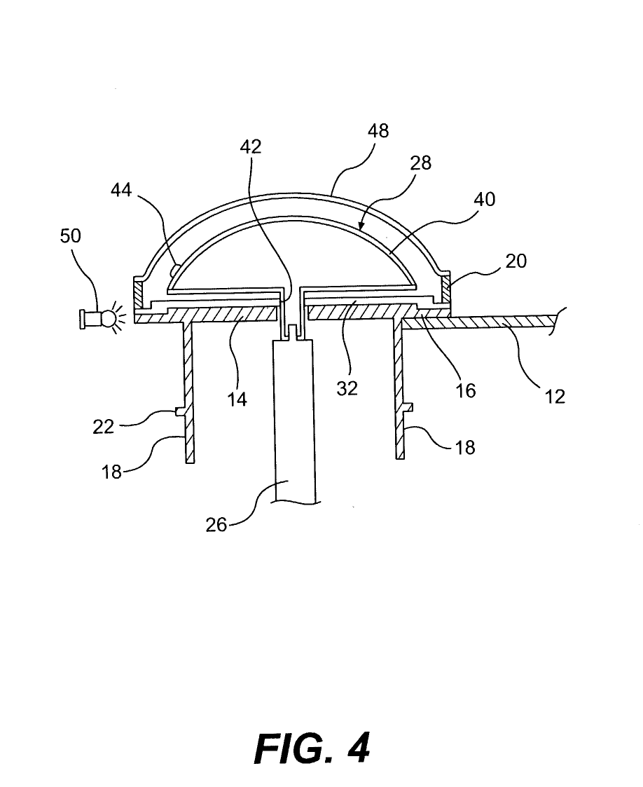

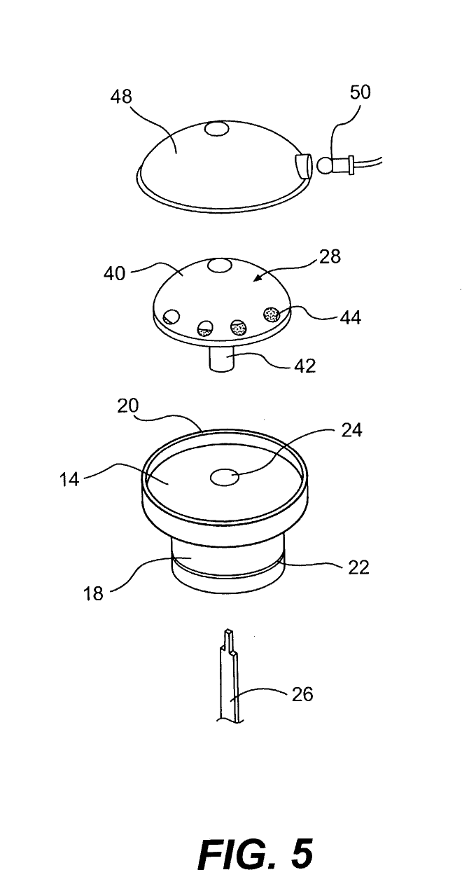

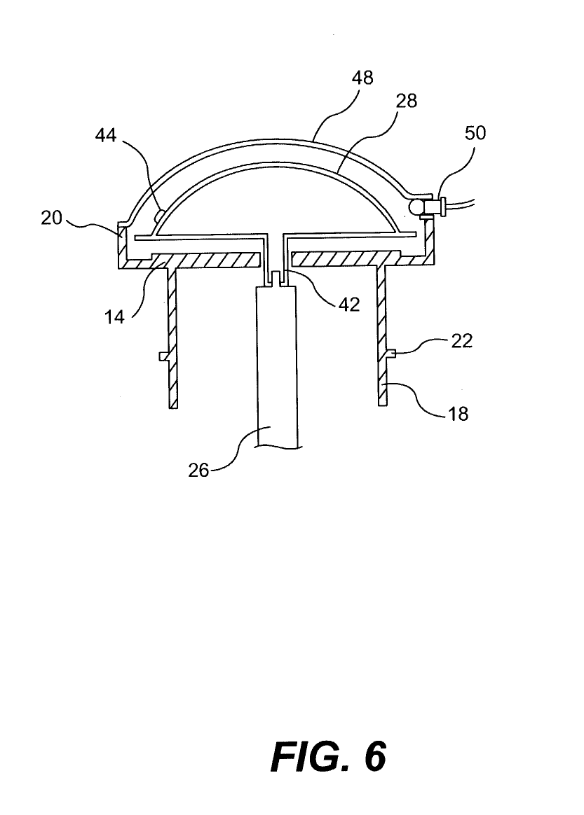

The body 14 also has a central hole 24 through which a twisted wire 26 passes. In the embodiment illustrated in FIG. 3, the twisted wire 26 connects to a dome-shaped indicator 28. In the embodiment depicted, the body 14 includes a semicircular grove 30, which extends preferably 180 degrees around the twisted wire 26. The semicircular groove 30 provides a suitable location for a light conductor 32. As shown in the FIGS. 3 and 4, the light conductor 32 is positioned in the groove 30 below the indicator 28. In a second embodiment shown in FIGS. 5 and 6, the light conductor 32 is a crystal 48, which will be described in greater detail below.

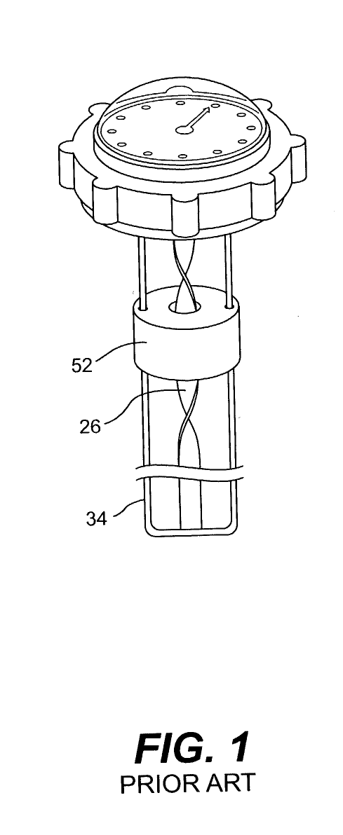

The twisted wire 26 is preferably made of metal with a rectangular cross-section. The rectangular cross-section facilitates forming the helical shape of the twisted wire 26. It also assists in the operation of the gauge 10, which will be described in greater detail below. The twisted wire 26 is rotatably mounted in a U-shaped carriage 34 that extends downwardly from the body 14, as shown in FIG. 1. The U-shaped carriage 34 has a hole 36 in a bottom portion into which a peg 38 (which is integral with the twisted wire 26) extends.

The indicator 28 is preferably made of a translucent material, which allows light emitted from the light conductor 32 to pass therethrough. However, as known by those skilled in the art, any suitable material may be used. The indicator 28 is preferably shaped like that of a mushroom, with a dome-shaped upper portion 40 and a vertical stem portion 42. The connection between the twisted wire 26 and the vertical stem portion 42 of the indicator 28 is preferably by a press-fit. However, as would be recognized by those skilled in the art, any method of attachment, which fixedly attaches the twisted wire 26 to the indicator 28, may be used. The indicator 28 has markings 44 on the dome-shaped upper portion 40 to indicate the level of fuel in the tank 12 with respect to a point of origin 46 (or marker) preferably located on a crystal 48.

As shown in FIGS. 3 and 4, a light source 50 is placed at the end of the light conductor 32 in the semi-circular grove 30 of the body 14. The light source 50 preferably is actuated by an alternating current. In a second embodiment shown in FIGS. 5 and 6, the light source is placed in the crystal 48. In this embodiment, the crystal 48 encloses the light source 50 and functions as a light conductor to direct light from the light source 50 to the indicator 28.

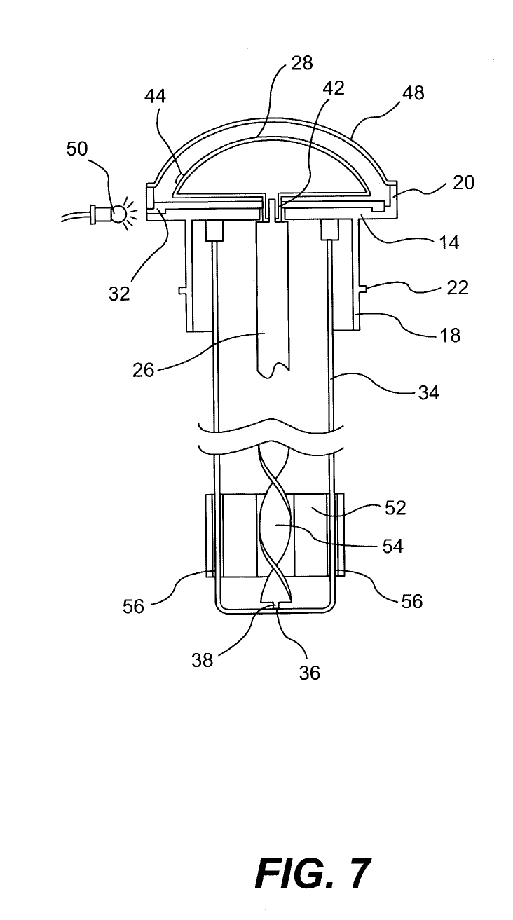

A float 52, shown in FIG. 7, has a round central bore 54 in the top portion and a rectangular slot in the lower portion. The twisted wire 26 extends through the central bore in the float 52. The float 52 also has two U-shaped groves 56 situated on each side that engage the two legs of the U-shaped carriage 34 and that fix the orientation of the float 52 when sliding along the twisted wire 26. As a result, as the float 52 moves vertically along the U-shaped carriage 34, the float 52 is held in a fixed orientation with respect to the U-shaped carriage 34 and, accordingly, the body 14. Since the float 52 is held in a fixed orientation, the twisted wire 26 rotates as the float moves up or down depending on the fuel level in the tank 12. This, in turn, causes the indicator 28 to rotate.

The crystal 48 provides protection for the indicator 28. The crystal 48 is preferably dome-shaped and made from a clear material so the indicator 28 can be seen therethrough. As shown in FIG. 3, the crystal 48 is placed over the body and contacts the body 14 at the peripheral edge where the crystal 48 and body 14 are affixed to one another, preferably forming a sealed inner chamber. This prevents fuel fumes from escaping from the tank 12 through the central hole 24.

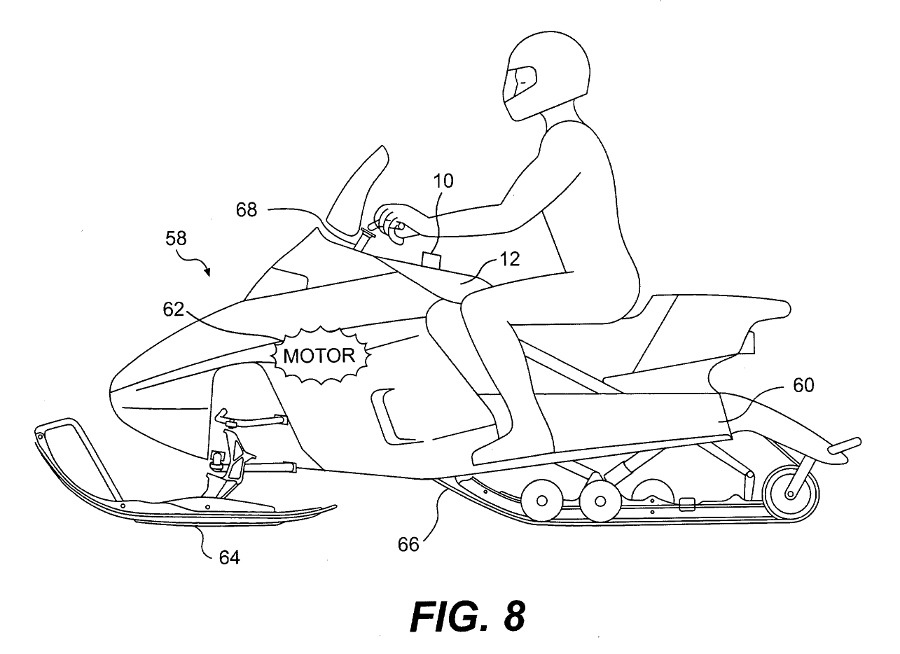

The gauge 10 of the present invention may be used on any suitable vehicle including a snowmobile 58, which is shown in FIG. 8. Snowmobile 58 has a chassis 60 on which the engine 62 is disposed. A pair of skis 64 are attached to the front portion of the chassis and are connected to a steering device 68 to steer the snowmobile 58 across a snow covered surface. An endless track 66, connected to the engine 62, is placed under the chassis 60 to propel the snowmobile 58. The snowmobile 58 includes the tank 12 and the gauge 10 described above.

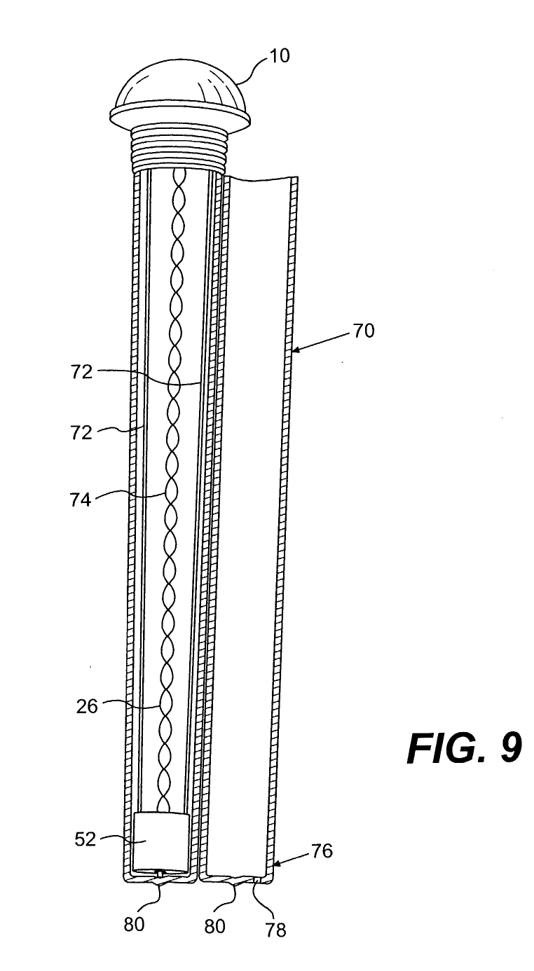

In still another embodiment shown in FIG. 9 of the present invention, an attenuator 70 is provided with the gauge 10. The attenuator 70, shown in FIG. 9, preferably has a cylindrical cross section defining a central bore in which the float 52 slides in response to the liquid level. Two rails 72 are placed on the inside wall 74 of the attenuator 70, maintaining the orientation of the float 53 as it slides within the attenuator 70.

Preferably the attenuator 70 is split in two parts to facilitate the placement of the float 52 therein. The bottom end 76 of the attenuator 70 includes a surface to prevent the float 52 from exiting the attenuator 70 when the fluid in the tank 12 is lower than the bottom of the attenuator 76. The bottom end 76 of the attenuator 70 also provides means for permitting fluid to enter the attenuator, preferably by a small hole 78. The bottom end 76 also includes a U-shaped protrusion (or dimple) 80 in which the twisted wire 26 rotates. However, as known by those skilled in the art, the attenuator 70 could be constructed in a different manner.

The attenuator 70 surrounds the float 52 to minimize transient fluctuations in the liquid level reading provided by the indicator 28. The liquid level measured by a fuel gauge, especially when in a moving vehicle such as a snowmobile, fluctuates considerably when the vehicle is operating. The reason for this is that movement of the vehicle establishes waves within the fuel tank 12. The float 52 moves on the U-shaped carriage 34 in response to these waves. Since the indicator 28 moves in response to movement by the float, the indicator 28 will vibrate considerably during operation of the vehicle.

To minimize transient movement of the indicator, the attenuator 70 prevents waves of fuel within the tank 12 from reaching the float 52. Instead, the float 52 is isolated from the waves in the tank 12, but the float 52 remains at the top of the fuel level within the tank 12. As a result, the indicator 28 provides a steady indication of the fuel level rather than a rapidly changing indication of the fuel level, which is unavoidable when the attenuator 70 is not provided.

While the invention has been described with reference to several preferred embodiments, it will be understood by those skilled in the art that various changes may be made and equivalents may be substituted for elements thereof without departing from the spirit and scope of the present invention. In addition, many modifications may be made to adapt a particular situation, component, or material to the teachings of the present invention without departing from its teachings as claimed.

What is claimed is:

1. A gauge, comprising:
a body;
a twisted wire disposed through the body;
an indicator fixedly disposed on the twisted wire;
a light source disposed adjacent the body to illuminate the indicator; and
a float slidably disposed on the twisted wire in a fixed orientation with respect to the body such that movement of the float along the twisted wire rotates the twisted wire and moves the indicator.

2. The gauge of claim 1, further comprising:
a light conductor to illuminate the indicator.

3. The gauge of claim 2, wherein the light source is disposed adjacent the light conductor so that light emitted from the light source is captured by the light conductor and directed to the indicator.

4. The gauge of claim 3, wherein the light conductor is a crystal disposed over the indicator.

5. The gauge of claim 3, wherein the light conductor is below the indicator.

6. The gauge of claim 1, wherein the indicator comprises a dome-shaped pictogram.

7. The gauge of claim 4, wherein the crystal is dome shaped.

8. The gauge of claim 5, wherein the body defines a cavity shaped to accept the light conductor.

9. The gauge of claim 8, wherein the cavity is semicircular and extends 180 degrees around the twisted wire.

10. The gauge of claim 1, further comprising:
a guide, parallel to the twisted wire, extending from the body and passing through the float such that the guide maintains the float in the fixed orientation as the float slides along the twisted wire.

11. The gauge of claim 10, further comprising:
an attenuator extending from the body and surrounding the twisted wire,
wherein the guide comprises tracks extending through the attenuator, and
wherein the attenuator is adapted to reduce substantially the effect of transient fluid fluctuations on the float.

12. The gauge of claim 10, wherein the guide is a U-shaped carriage extending from the body parallel to the twisted wire.

13. The gauge of claim 12, wherein the gauge is adapted to be disposed within a fuel tank to indicate a level of fuel therein.

14. The gauge of claim 13, wherein the fuel tank is attached to a vehicle.

15. The gauge of claim 14, wherein the vehicle is a snowmobile.

16. The gauge of claim 2, wherein the gauge is adapted to be disposed within a fuel tank to indicate a level of fuel therein.

17. The gauge of claim 16, wherein the fuel tank is attached to a vehicle.

18. The gauge of claim 17, wherein the vehicle is a snowmobile.
